(19) United States
(12) Patent Application Publication
(10) Pub. No.: US 2007/0289375 A1
(43) Pub. Date: Dec. 20, 2007

(54) Homogenous Fluid Level Sensing Devices

(75) Inventors: Gary Helstern, Newton, CT (US); Charles E. Dubois, Sandy Hook, CT (US)

Correspondence Address: DINSMORE & SHOHL LLP, ONE DAYTON CENTRE, ONE SOUTH MAIN STREET, SUITE 1300, DAYTON, OH, 45402-2023, US

(73) Assignee: DIBA INDUSTRIES, INC., Danbury, CT (US)

(21) Appl. No.: 11/423,983

(22) Filed: Jun. 14, 2006

(51) Int. Cl. G01F 23/24; G01F 23/26

(52) U.S. Cl. 73/304 R; 73/304 C

(57) ABSTRACT

The present invention relates to homogenous fluid level sensing devices that comprise a probe body configured to insert into a container and sense a level of fluid held therein. Generally, the probe body is configured such that conductors are exposed at a sensing end of the probe body and changes in an electrical signal across the conductors can be correlated with the presence or absence of fluid at the sensing end of the probe body. The present invention also relates to a method of manufacturing a probe body through a process of co-extrusion.

### BACKGROUND OF THE INVENTION

The present invention relates to homogenous fluid level sensing devices that comprise a probe body configured to sense a level of fluid held in a container. The present invention also relates to a method of manufacturing a probe body through a process of co-extrusion.

### BRIEF SUMMARY OF THE INVENTION

The present invention relates to homogenous fluid level sensing devices that comprise a probe body configured to be inserted into a container to provide a means for sensing a level of fluid held in the container. Generally, the probe body is configured such that conductors are exposed at a sensing end of the probe body and changes in an electrical signal across the conductors can be correlated with the presence or absence of fluid at the sensing end of the probe body.

In accordance with one embodiment of the present invention, a fluid level sensing device comprises a probe body that defines a cross sectional profile comprising a fluid channel, at least two conductors, and a dielectric body portion. The fluid channel is configured to extend along a longitudinal axis of the probe body, within the dielectric body portion. The conductors also are configured to extend along this longitudinal axis of the probe body and are embedded within the dielectric body portion. Thus, the conductors are electrically isolated from each other by the dielectric body portion. These conductors are provided such that each conductor is exposed at a sensing end of the probe body. Further, the conductors are electrically coupled to a fluid level sensing circuit.

In accordance with another embodiment of the present invention, a fluid level sensing device comprises a probe body, a fluid level sensing circuit, and a container at least partially filled with fluid. This fluid level sensing circuit is configured to monitor changes in an electrical signal across the conductors of the probe body.

In accordance with yet another embodiment, the present invention relates to a method of manufacturing a fluid level sensing device that comprises a probe body. This method comprises co-extruding a dielectric material and an electrically conductive material such that the probe body comprises at least two conductors formed of the electrically conductive material, a fluid channel, and a dielectric body portion formed of the dielectric material. The configuration of this probe body formed through this method is consistent with the probe body embodiments described herein.

Accordingly, it is an object of the present invention to present fluid level sensing devices that comprise a probe body. Other objects of the present invention will be apparent in light of the description of the invention embodied herein.

### BRIEF DESCRIPTION OF THE SEVERAL VIEWS OF THE DRAWINGS

The following detailed description of specific embodiments of the present invention can be best understood when read in conjunction with the following drawings, where like structure is indicated with like reference numerals and in which:

FIG. 1 is an illustration of an embodiment of a probe body comprising a fluid channel, at least two conductors, and a dielectric body portion;

FIG. 2 is an illustration presenting the fluid channel and conductors extending along the longitudinal axis of the probe body; and

FIG. 3 is an illustration of a fluid level sensing device comprising a container at least partially filled with fluid, a probe body, and a sensing circuit connector.

### DETAILED DESCRIPTION

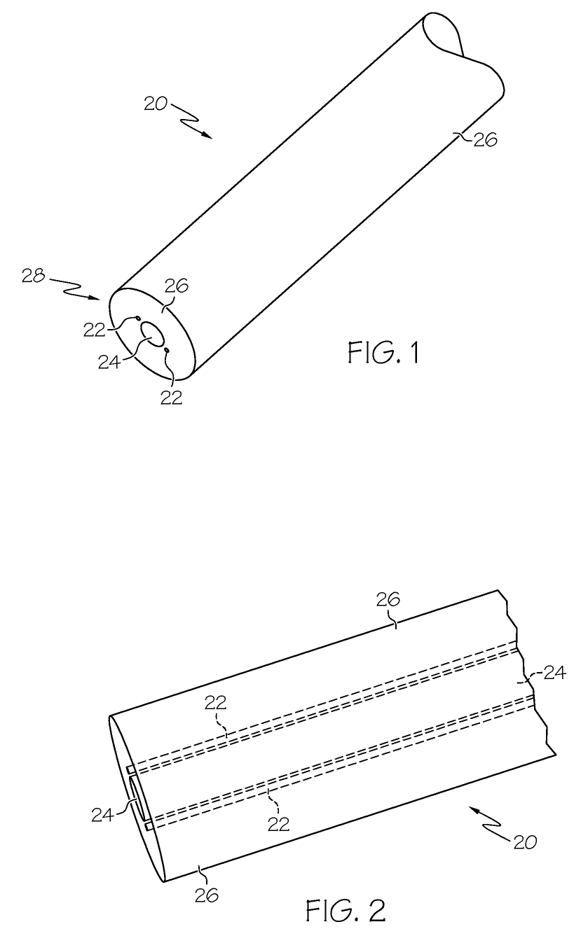

Referring to FIGS. 1 and 2, fluid level sensing devices according to the present invention generally comprise a homogenous probe body 20 that defines a cross sectional profile comprising at least two conductors 22, a fluid channel 24, and a dielectric body portion 26. Methods of extrusion, injection molding, or other similar methods may be used to configure this cross sectional profile defined by the probe body 20.

The conductors 22 are configured to extend along a longitudinal axis of the probe body 20 and are embedded within the dielectric body portion 26 such that the conductors 22 are electrically isolated from each other by the dielectric body portion 26. More specifically, as shown in FIGS. 1 and 2, the conductors 22 are bound by the dielectric body portion 26 of the probe body 20 such that generally only the end portions of the conductors 22 are exposed from of the dielectric body portion 26 at a sensing end 28 of the probe body 20. The conductors 22 may be configured of a metallic material or any other suitable electrically conductive material and may be configured such that they are resistant to degradation upon exposure to fluids. For example, in one embodiment of the present invention, the conductors 22 are stainless steel wires.

Similar to the conductors 22, the fluid channel 24 is configured to extend along the longitudinal axis of the probe body 20, within the dielectric body portion 26. The probe body 20 is configured to pass fluid 10 through this fluid channel 24. Meanwhile, the dielectric body portion 26 generally is configured of a polymer material. For example, the dielectric body portion 26 can be configured of a fluoro-polymer material.

As also shown in FIGS. 1 and 2, the probe body 20 may be provided such that the sensing end 28 of the probe body 20 is configured as an end surface comprising a section of the dielectric body portion 26 and exposed portions of the conductors 22. In one embodiment of the probe body 20, the exposed portions of the conductors 22 may be flush with the end surface of the sensing end 28 so as to create a substantially continuous planar surface. In an alternative embodiment of the probe body 20, the exposed ends of the conductors 22 may protrude from the end surface of the sensing end. This protrusion of the conductors 22 may be slight or to any extent desired by a user of the fluid level sensing device.

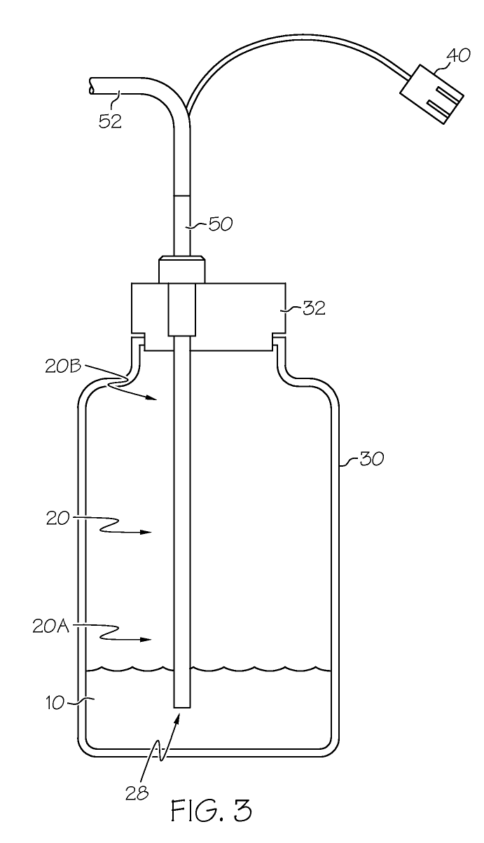

The fluid level sensing circuit electrically coupled to the conductors 22 generally is provided to monitor changes in an electrical signal across the conductors 22. For example, and not by way of limitation, the fluid level sensing circuit can be configured to monitor changes in conductivity or capacitance between the conductors and correlate the changes in conductivity or capacitance with the presence or absence of fluid at the sensing end 28 of the probe body 20. Thus, the fluid level sensing device of the present invention can be used to provide an indication of fluid level within the container 30 by correlating the presence or absence of fluid at the sensing end 28 of the probe body 20 with the height of the sensing end 28 within the container 30. A sensing circuit connector 40, shown in FIG. 3, may be used to electrically couple the conductors 22 to the fluid level sensing circuit. In practicing the present invention, it may be necessary to remove portions of the dielectric body portion 26 from the vicinity of the conductors 22, e.g, through scalping or otherwise, to enable proper electrical coupling of the sensing circuit, sensing circuit connector 40, or other associated wiring to the conductors 22. The particular design of the fluid level sensing circuit is beyond the scope of the present invention and, as will be appreciated by those practicing the present invention, it is contemplated that any suitable circuitry for monitoring changes in an electrical signal across the conductors 22 may be utilized in the context of the present invention. It is also noted that the fluid level sensing circuit is not shown in the appended drawings because its particular structure is beyond the scope of the present invention and would merely be represented schematically as a block element.

Further, as shown in FIG. 3, the probe body 20 may comprise a fluid contacting portion 20A and an upper portion 20B. This fluid contacting portion 20A may be configured as an elongate member that is free of substantial fluid holding discontinuities that would otherwise cause adhesion of fluid droplets to the probe body 20. Such a configuration ensures that the fluid contacting portion 20A does not “hold-up” fluid 10 if the fluid level falls beneath the sensing end 28 of the probe body 20. This configuration avoids cross-contamination of fluids as the probe body 20 is removed from one container containing one fluid and placed in another container containing another fluid. For the purposes of describing and defining the present invention, it is noted that substantial fluid holding discontinuities are those that retain or “hold-up” enough fluid to pose contamination or other fluid transfer issues when removing the probe body 20 from a container.

The fluid level sensing device of the present invention may further comprise a mechanical arm or other similarly functioning device. This mechanical arm may be secured to the upper portion 20B of the probe body 20 such that the probe body 20 may be maneuvered by the mechanical arm. For example, the mechanical arm may be used to maneuver the probe body 20 from one container from which it aspirates fluid 10 to another container in which it dispenses said fluid 10.

Also shown in FIG. 3, the fluid level sensing device of the present invention may further comprise a container 30 that is at least partially filled with fluid 10 in addition to the probe body 20. This container 30 may, but need not necessarily, comprise a cap 32 through which a probe body 20 may pass to prevent a spillage of fluid 10 over the top of the container 30.

Further, in another embodiment of the fluid level sensing device of the present invention where a probe body 20 is provided in a length insufficient to reach another device or system of the user, the fluid level sensing device may also comprise a tube fitting 50 and a length of tubing 52. As shown in FIG. 3, this tube fitting 52 may be configured to couple the end of the upper portion 20B of the probe body 20 to the length of tubing 52 without compromising the electrical coupling of the conductors 22 to the fluid level sensing circuit described herein. Further, the tube fitting 52 may be configured to engage a cap 32, if present, of the container 30 so as to localize the position of the probe body 20 in the container 30 and to aid in preventing spillage of fluid 10 over the top of the container 30. The length of tubing 52 may be coupled at one end to the probe body 20 by the tube fitting 50 and connected at another end to a user's other device or system so as to pass fluid 10 to or from the container 30. Thus, while the probe body 20 of the present invention generally is intended to be provided in a length sufficient to reach the location of another device or system of the user, it is contemplated by the present invention that circumstances may arise where the length of the provided probe body 20 is insufficent to reach where it is needed and may be complemented by the herein described tube fitting 50 and length of tubing 52.

A fluid level may be recognized as low or high depending on whether the probe body 20 and the container 30 at least partially filled with fluid 10 serve as a supply system of fluid 10 or as a disposal system for waste material. In the context of a container 30 carrying a supply of fluid 10, the probe body 20 can be positioned at a relatively low level in the container 30 to provide signals indicative of relatively low fluid levels or an “empty” or “near empty” condition within the container 30 when the fluid level falls beneath the sensing end 28 of the lowly positioned probe body 20. Thus, the fluid level sensing device may indicate a low fluid level when a supply of fluid 10 is nearly expended and needs replenished. Alternatively, in the context of a container 30 being filled with waste material, or another type of fluid, the probe body 20 can be positioned at a relatively high level in the container 30 to provide signals indicative of relatively high fluid levels or a “full” or “nearly full” condition within the container 30 when the fluid level rises to reach the sensing end 28 of the highly positioned probe body 20. Thus, the fluid level sensing device may indicate a high fluid level when a level of waste material reaches a maximum fluid level of the container 30.

The fluid level sensing device of the present invention may further comprise a structural housing configured to provide greater dimensional stability to the probe body 20, if needed. Preferably, the housing is configured of stainless steel and is applied to the probe body such that the housing avoids substantial contact with fluids.

It is contemplated by the present invention that the conductors 22 may be provided to the probe body 20 in any configuration where the conductors 22 extend along the longitudinal axis of the probe body 20, are embedded within the dielectric body portion 26, and are electrically isolated from each other. By ways of example, but not of limitation, such configurations may be where the conductors 22 are parallel to each other and the fluid channel 24 or wrap helically about the fluid channel 24. For purposes of the present invention, the description that the conductors 22 and the fluid channel 24 extend along the longitudinal axis of the probe body 20 simply means that the conductors 22 and the fluid channel 24 extend from one end of the probe body 20 to the other. Thus, the conductors 22 and the fluid channel 24 may be, but are not necessarily, parallel to one another.

It is further contemplated by the present invention that the probe body 20 may be provided in a variety of configurations. For example, the probe body 20 and/or the fluid channel 24 may be provided in an angular or circular cross-sectional configuration, or combinations thereof. In addition, the probe body 20 and/or the fluid channel 24 may be configured with any diameter or width that is feasible through the process of co-extrusion or injection molding. Further, the probe body 20 may be provided in any length desired by a user of the fluid level sensing device according to the present invention. Thereby, the probe body 20 may be provided in a length sufficient to eliminate any need for the tube fitting 50 or the length of tubing 52 described herein.

The present invention further relates to a method of manufacturing a fluid level sensing device that comprises a probe body 20. This method comprises co-extruding a dielectric material and an electrically conductive material such that the probe body 20 is configured as an elongate member free of substantial fluid holding discontinuities. This probe body 20 comprises at least two conductors 22 formed of the electrically conductive material, a fluid channel 24, and a dielectric body portion 26 formed of the dielectric material. The configuration of this probe body 20 formed through this method is consistent with the probe body 20 embodiments described herein.

The method of manufacturing a fluid level sensing device according to the present invention forms a homogenous fluid level sensing probe body 20 that is free of substantial fluid holding discontinuities that may hold-up droplets of fluid 10 on the probe body 20. More specifically, the co-extrusion process of the present invention yields a probe body 20 that is not subject to post-manufacture creep or stress between plastic and metal components of the probe body 20. As a result, the probe body 20 of the present invention is less likely to include fluid holding discontinuities that would otherwise develop during and after probe manufacture. By using the process of co-extrusion, this method avoids the creation of these discontinuities and the risk of cross-contamination of fluids described above.

It is noted that terms like “preferably,” “commonly,” and “typically” are not utilized herein to limit the scope of the claimed invention or to imply that certain features are critical, essential, or even important to the structure or function of the claimed invention. Rather, these terms are merely intended to highlight alternative or additional features that may or may not be utilized in a particular embodiment of the present invention.

For the purposes of describing and defining the present invention it is noted that the term “device” is utilized herein to represent a combination of components and individual components, regardless of whether the components are combined with other components. For example, but not by way of limitation, a “device” according to the present invention may comprise a probe body 20, a container 30 at least partially filled with fluid 10, and a fluid level sensing circuit.

For the purposes of describing and defining the present invention it is noted that the term “substantially” is utilized herein to represent the inherent degree of uncertainty that may be attributed to any quantitative comparison, value, measurement, or other representation. The term “substantially” is also utilized herein to represent the degree by which a quantitative representation may vary from a stated reference without resulting in a change in the basic function of the subject matter at issue.

Having described the invention in detail and by reference to specific embodiments thereof, it will be apparent that modifications and variations are possible without departing from the scope of the invention defined in the appended claims. More specifically, although some aspects of the present invention are identified herein as preferred or particularly advantageous, it is contemplated that the present invention is not necessarily limited to these preferred aspects of the invention.

What is claimed is:

1. A fluid level sensing device comprising a probe body, wherein:
said probe body defines a cross sectional profile comprising a fluid channel, at least two conductors, and a dielectric body portion;
said fluid channel is configured to extend along a longitudinal axis of said probe body, within said dielectric body portion;
said conductors are configured to extend along said longitudinal axis of said probe body;
said conductors are embedded within said dielectric body portion and are electrically isolated from each other by said dielectric body portion;
said conductors are provided such that each of said conductors are exposed at a sensing end of said probe body; and
said conductors are electrically coupled to a fluid level sensing circuit.

2. The fluid level sensing device of claim 1, wherein said sensing end of said probe body is configured as an end surface comprising a section of said dielectric body portion and exposed portions of said conductors.

3. The fluid level sensing device of claim 2, wherein said exposed portions of said conductors are flush with said end surface of said sensing end so as to create a substantially continuous planar surface.

4. The fluid level sensing device of claim 2, wherein said exposed portions of said conductors protrude from said end surface of said sensing end.

5. The fluid level sensing device of claim 1, wherein
said probe body comprises a fluid contacting portion and an upper portion; and
said fluid contacting portion is configured as an elongate member free of substantial fluid holding discontinuities.

6. The fluid level sensing device of claim 1, wherein said dielectric body portion is configured of a polymer material.

7. The fluid level sensing device of claim 1, wherein said fluid level sensing circuit is configured to monitor changes in an electrical signal across said conductors.

8. The fluid level sensing device of claim 7,wherein said fluid level sensing circuit is further configured to correlate the changes in said electrical signal with a presence or absence of fluid at said sensing end of said probe body.

9. The fluid level sensing device of claim 1, wherein said fluid level sensing device further comprises a container at least partially filled with fluid in addition to said probe body.

10. The fluid level sensing device of claim 9, wherein said container comprises a cap through which passes said probe body.

11. The fluid level sensing device of claim 1, wherein said fluid level sensing device further comprises a tube fitting and a length of tubing.

12. The fluid level sensing device of claim 11, wherein said tube fitting is configured to couple an end of said probe body to an end of said length of tubing.

13. The fluid level sensing device of claim 11, wherein said tube fitting is configured to engage a cap of a container at least partially filled with fluid so as to localize a positioning of said probe body in said container.

14. The fluid level sensing device of claim 1, wherein said fluid level sensing device further comprises a mechanical arm.

15. The fluid level sensing device of claim 14, wherein said mechanical arm is secured to an upper portion of said probe body such that said probe body is maneuverable by said mechanical arm.

16. A fluid level sensing device comprising a probe body, a fluid level sensing circuit, and a container at least partially filled with fluid, wherein:
said probe body defines a cross sectional profile comprising at least two conductors, a fluid channel, and a dielectric body portion;
said probe body is configured to pass fluid through said fluid channel;
said conductors are embedded within said dielectric body portion and are electrically isolated from each other by said dielectric body portion;
said conductors are provided such that each of said conductors are exposed at a sensing end of said probe body; and
said fluid level sensing circuit is configured to monitor changes in an electrical signal across said conductors.

17. A method of manufacturing a fluid level sensing device comprising a probe body by co-extruding a dielectric material and an electrically conductive material such that:
said probe body is configured as an elongate member free of substantial fluid holding discontinuities;
said probe body comprises at least two conductors formed of said electrically conductive material, a fluid channel, and a dielectric body portion formed of said dielectric material;
said fluid channel is configured to extend along a longitudinal axis of said probe body, within said dielectric body portion;
said conductors are configured to extend along said longitudinal axis of said probe body;
said conductors are electrically isolated from each other by said dielectric body portion; and
said conductors are provided such that each of said conductors are exposed at a sensing end of said probe body.
